(19) United States
(12) Patent Application Publication
(10) Pub. No.: US 2009/0125334 A1
(43) Pub. Date: May 14, 2009

(54) Method and System for Radiation Oncology Automatic Decision Support

(75) Inventors: Sriram Krishnan, Exton, PA (US); Debarshi Datta, Old Bridge, NJ (US); R. Bharat Rao, Berwyn, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA. Inc., Malvern, PA (US)

(21) Appl. No.: 12/255,100

(22) Filed: Oct. 21, 2008

Related U.S. Application Data
(60) Provisional application No. 60/981,631, filed on Oct. 22, 2007.

(51) Int. Cl. G06Q 50/00; G06F 17/00; G06F 17/30

(52) U.S. Cl. 705/3; 705/2; 705/10

(57) ABSTRACT

A method for providing automatic decision support for the selection of a treatment protocol includes receiving information pertaining to the patient, the condition and the preferences partially or wholly by automatically parsing patient records. The information pertaining to the patient, the condition and the preferences may be partially or wholly ascertained by prompting a user for manual input of the desired data. The information is used to calculate one or more surrogate variables. A knowledge base including a plurality of treatment protocols is accessed and one or more of the plurality of treatment protocols are selected from the knowledge base based on the received information pertaining to the patient, the condition, and the preferences, the surrogate variables, and using a probabilistic framework. The selected treatment protocols are provided as treatment guidance.

### CROSS-REFERENCE TO RELATED APPLICATION

The present application is based on provisional application Ser. No. 60/981,631, filed Oct. 22, 2007, the entire contents of which are herein incorporated by reference.

### BACKGROUND OF THE INVENTION

1. Technical Field

The present disclosure relates to decision support and, more specifically, to a method and system for radiation oncology automatic decision support.

2. Discussion of Related Art

Modern information systems continue to change the way in which healthcare is administered. Traditionally medical practitioners such as physicians, relying on their extensive training and expertise, would diagnose and treat a patient by manually reviewing patient records, ordering tests, reviewing tests, determining a course of treatment, and following up with the patient to review the success of the treatment. Today, while this basic approach is still followed, modern information systems may be used to aid the medical practitioner in a number of aspects. For example, patient records may be stored electronically in a database for efficient retrieval.

Additionally, progress has been made in the field of computerized decision support. Decision support pertains to the use of a computer system and computer program to receive a set of patient characteristics and apply a set of pre-determined rules to arrive at a recommended diagnosis and/or suggested course of treatment.

In these conventional decision support systems, the medical practitioner or another user may be required to manually input the set of patient characteristics from multiple sources into the computer system. The computer system then applies the set of pre-determined rules to the available data. Assuming all of the required data has been properly input, the computer system is able to output its recommended diagnosis and/or suggested course of treatment based on the systematic application of the pre-determined rules.

Under such a system, the rules themselves may be designed by one or more medical health experts, and coded by a computer programmer. The rules may represent a sophisticated decision tree that may have been designed with the medical knowledge available at the time of design.

While such a decision support system may be effective, as medical research progresses, the state of medical knowledge is constantly expanding. When new and important medical knowledge is obtained, the set of rules may have to be modified to reflect the new knowledge. Because of the complexity of the decision tree, it is often difficult to update the set of pre-determined rules. Updating of the rules is rarely as simple as adding or removing one or two rules, often the new knowledge requires a complete redesign of the decision tree followed by reprogramming on the part of the computer programmer.

Additionally, the set of rules that are based on the decision tree may not be able to effectively process the patient characteristic data that has been manually input if one or more key items of data are not present. For example, if information pertaining to whether the patient is a smoker or a nonsmoker has not been input, the rigidity of the pre-determined set of rules may not be able to continue in the decision tree when arising at a rule that requires knowledge about whether the patient is a smoker. Such a lack of required characteristic data can result in a failure of the decision support system to provide a recommended diagnosis and/or suggested course of treatment.

Accordingly, existing decision support systems may be inflexible, non-robust and difficult to update to reflect advances in medical knowledge.

### SUMMARY

A method for providing automatic decision support for the selection of a treatment protocol includes receiving information pertaining to a patient, a condition of the patient, and patent preferences. A knowledge base including a plurality of treatment protocols is accessed. One or more of the plurality of treatment protocols are selected from the knowledge base based on the received information pertaining to the patient, the condition, and the preferences, and using a probabilistic framework. The selected treatment protocols are provided as treatment guidance.

The information pertaining to the patient, the condition and the preferences may be partially or wholly ascertained by automatically parsing patient records. The patient records may include one or more of doctor's notes, patient billing records, patient medical histories, diagnoses, and medical images. The information pertaining to the patient, the condition and the preferences may be partially or wholly ascertained by prompting a user for manual input of the desired data.

The information pertaining to the condition of the patient may include information about an instance of cancer. The information pertaining to the patent preferences may include information about the patient's tolerance for adverse side effects.

The information pertaining to the patient, the condition and the preferences may be used to calculate one or more surrogate variables that may also be used in selecting the treatment protocols from the knowledge base using a probabilistic framework.

The knowledge base may additionally include likelihood functions for one or more of the plurality of treatment protocols. The selected treatment protocols may be selected from the knowledge base for having a highest probability as determined by the probabilistic framework. The selected treatment protocols may be selected from the knowledge base for having a probability greater than a predetermined threshold as determined by the probabilistic framework.

The provided treatment guidance may include the selected treatment protocols as well as a confidence interval for each selected treatment protocol that is based on the respective probability as determined by the probabilistic framework. The provided treatment guidance may include predictive outcomes for the selected treatment protocols.

A system for providing automatic decision support for the selection of a treatment protocol includes a record parsing unit for parsing patient records for information pertaining to a patient, a condition of the patient, or patent preferences; an input device for receiving additional information pertaining to a patient, a condition of the patient, or patent preferences; a knowledge base including a plurality of treatment protocols; a logic unit employing a probabilistic framework for selecting one or more of the plurality of treatment protocols from the knowledge base based on the parsed information and the received additional information pertaining to the patient, the condition, and the preferences; and a display device for displaying the selected treatment protocols as treatment guidance.

The record parsing unit may automatically parse one or more of doctor's notes, patient billing records, patient medical histories, diagnoses, and medical images for information pertaining to a patient, a condition of the patient, or patent preferences.

The information pertaining to the patent preferences may include information about the patient's tolerance for adverse side effects. The knowledge base may additionally include likelihood functions for one or more of the plurality of treatment protocols.

The selected treatment protocols may be selected from the knowledge base for having a highest probability as determined by the probabilistic framework. The selected treatment protocols may be selected from the knowledge base for having a probability greater than a predetermined threshold as determined by the probabilistic framework.

The displayed treatment guidance may include the selected treatment protocols as well as a confidence interval for each selected treatment protocol that is based on the respective probability as determined by the probabilistic framework. The displayed treatment guidance may include predictive outcomes for the selected treatment protocols.

A computer system includes a processor and a program storage device readable by the computer system, embodying a program of instructions executable by the processor to perform method steps for providing automatic decision support for the selection of a treatment protocol. The method includes receiving information pertaining to a patient, a condition of the patient, and patent preferences; accessing a knowledge base including a plurality of treatment protocols; selecting one or more of the plurality of treatment protocols from the knowledge base based on the received information pertaining to the patient, the condition, and the preferences, and using a probabilistic framework; and providing the selected treatment protocols as treatment guidance.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating an approach to decision support according to an exemplary embodiment of the present invention;

FIG. 2 is a flow chart illustrating an approach to decision support, each according to an exemplary embodiment of the present invention; and

FIG. 3 shows an example of a computer system capable of implementing the method and apparatus according to embodiments of the present invention.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention relate to a method and system for providing automatic decision support, particularly in the field of radiation oncology, where there may be a relatively great number of relevant patient characteristics and an equally great number of possible treatment protocols to consider.

While exemplary embodiments of the present invention may be described as applied to radiation oncology, it is to be understood that the methods and systems described herein may be applied to other medical fields of study without departing from the spirit and scope of the present invention. Exemplary embodiments of the present invention are described herein with respect to radiation oncology for the purposes of providing a simplified explanation, and to illustrate the application of exemplary embodiments of the present invention to a field of medicine for which it is particularly suited.

In radiation oncology, there are a large number of available treatment protocols that may be applied to a given patient. For example, a patient with lung cancer may be treated using surgery, radiation therapy, chemotherapy, and/or other available treatments. Moreover, there may be a great variety in how each particular treatment type may be applied. For example, there are a great number of drugs that may be administered as part of chemotherapy, and each drug may be administered in multiple dosages. Similarly, there are many different varieties of radiation therapies including different dosages of ionizing radiation, different fractionations, and different lengths of time.

The determination as to an appropriate course of treatment is often made by the treating physician. Ultimately, the determination as to an appropriate course of treatment may be made based upon cancer characteristics, patient characteristics, patient preferences and the knowledge and expertise of the treating physician.

Cancer characteristics are the features that describe the form of cancer being treated as well as its stage of advancement. For example, “lung cancer, stage II” may be a cancer characteristic. Cancer characteristics may also be more specific and may include lesion size, shape, degree and other features that may be assessed by biopsy and/or medical image. Patient characteristics are the data that describe the patient's family history, the patient's medical history such as previous instances of cancer, and any other information about the patient that may be relevant to treatment. For example, “age and co-morbidities” may be instances of patient characteristics. Patient preferences may include an assessment of how aggressive a treatment the patient is capable of enduring. Patient preferences may include information pertaining to how to weigh a likelihood of cure against risk of side effects.

Conventionally, these characteristics may be analyzed in light of the experience and training of the treating physician. The treating physician may then determine a course of treatment that may include selection of one or more treatment protocols.

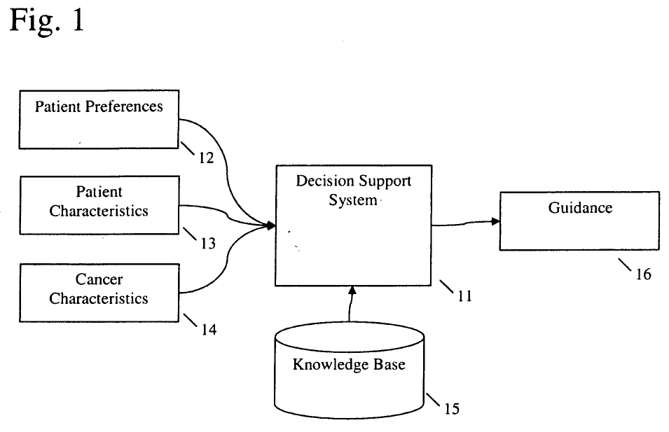

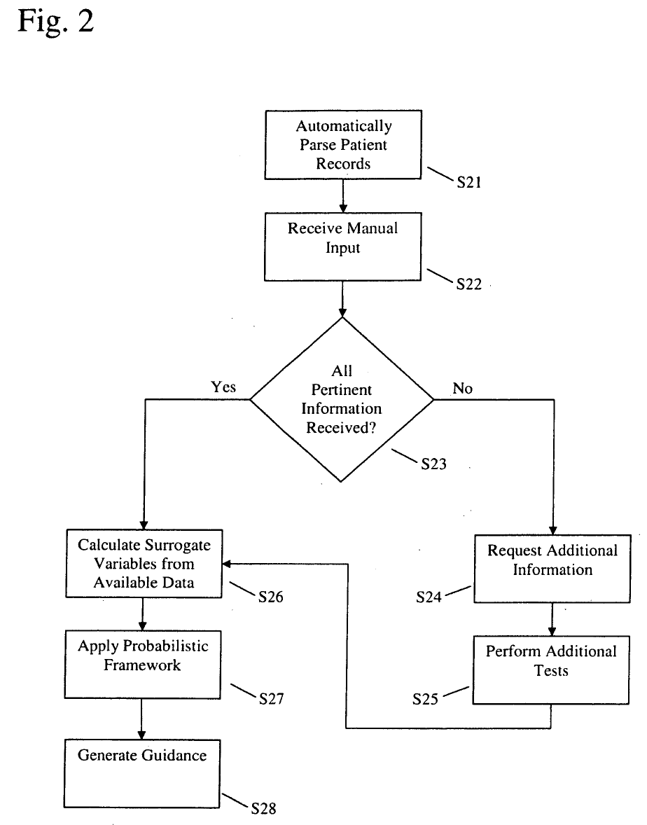

Exemplary embodiments of the present invention utilize a method and system for receiving one or more characteristics and automatically generating a recommended course of treatment that may include the selection of one or more treatment protocols. FIG. 1 is a block diagram illustrating an approach to decision support and FIG. 2 is a flow chart illustrating an approach to decision support, each according to an exemplary embodiment of the present invention.

In FIG. 1, the decision support system 11 receives patient preferences 12, patient characteristics 13, and cancer characteristics 14. As illustrated in the flow chart of FIG. 2, the receiving of these preferences and characteristics may be accomplished by automatically parsing patient records (Step S21) and by receiving manual input (Step S22).

To the greatest extent possible, the patient preferences 12, patient characteristics 13, and cancer characteristics 14 may be extracted from patient records in Step S21. This may be accomplished, for example, from comparing a list of desired data against the information available in the patient records. The patient records may include text files, XML files, and/or files from a proprietary database. Where, for example, the patient record files include structured data such as data in proprietary database formats and/or XML, the pertinent data may already be identified according to the type of data that it is, for example, by the use of tags that indicate what each subset of data is. Where the data is so structured, data extraction may be performed by searching for desired tags and extracting the data associated with the desired tags.

Where the patient records are not effectively tagged (unstructured) or where the data is structured according to a syntax that cannot be understood, parsing may include the use of artificial intelligence techniques to read the patient records and identify the pertinent data based on syntax and contextual clues. For example, the patient records may be automatically parsed using software such as Reliable Extraction and Meaningful Inference from Nonstructured Data (REMIND) offered by Siemens Medical Solutions, a subsidiary of Siemens AG, and discussed in U.S. Pat. No. 7,181,375, to Rao et al., issued Feb. 20, 2007, herein incorporated by reference. Such software may be able to parse unstructured data such as doctor's notes, patient billing records, patient medical histories, diagnoses, and medical images such as X-rays and extract useful information such as patient preferences 12, patient characteristics 13, and cancer characteristics 14.

Exemplary embodiments of the present invention may be able to generate decision support guidance 16 using what ever amount of data is available, and thus it is not required that additional information be manually input after automatic parsing has been performed. However, additional information may be collected in addition to the information collected by the automatic parsing of the patient records (Step S21) and that this additional information may be used to produce guidance 16 that is of greater value than guidance 16 produced by the automatic parsing alone. Accordingly, manual input of additional data may be received (Step S22).

The additional data may be received in response to a display provided by the decision support system 11 asking that particular information be entered. The receiving of the additional information (Step S22) may come after the automatic parsing (Step S21) and thus the decision support system 11 may specifically request pertinent information that was unavailable through the automatic parsing of the patient records. Alternatively, the receiving of the additional information (Step S22) may come before the automatic parsing (Step S21) in which case the automatic parsing may be limited to the finding of data that was not manually entered.

After both automatic parsing of the patient records (Step S21) and receiving of the manual inputted data (Step S22) it might still be the case that all pertinent information has not been received, where this is the case (No, Step S23), the decision support system 11 may recommend that additional information be collected (Step S24). The collection of additional information may include the performance of additional tests (Step S25), collection of previously unknown data, or some other pertinent information. This request for additional information (Step S24) may occur either before guidance 16 has been generated or thereafter. For example, the request for additional information may occur prior to the display of the guidance 16, or along with the display of guidance 16.

In either event, the generation of guidance 16 (Step S28) does not require that every item of potentially useful information be collected and thus the decision support system 11 is robust and flexible enough to generate guidance 16 using only what ever information is presently available. Thus regardless of whether all pertinent information has indeed been received (Yes, Step S23) or not received (No, Step S23), the available data may be used to calculate surrogate variables (Step S26).

Surrogate variables represent information that has not been directly collected but can be determined from the information that has already been collected, either by straight conversion, with the aid of assumption, and/or by analysis performed using multiple items of collected information. Exemplary embodiments of the present invention may be able to reform the available data into other data of enhanced value by the calculation of the surrogate variables.

The decision support system may then utilize the available data; including the automatically parsed patient record data and the received manual inputted data; including patient preference data, patient characteristic data and cancer characteristic data; and the calculated surrogate variables and apply a probabilistic framework to this data using a knowledge base of existing protocols 15 (Step S27).

The knowledge base of existing protocols 15 may be a database including all of the available treatment regiments, including surgical treatments, chemotherapeutic treatments, radiation treatments, and/or other forms of treatment, be they curative, preventative, or palliative. The included protocols may include information such as the medications to administer, recommended dosages, different fractionations, different lengths of time, and/or any other pertinent information regarding the course of treatment.

The knowledge base 15 may include a set of the protocols as described above, and need not include rules or other implementations of a linear decision tree. Additional protocols may be added, as desired and existing protocols may be deleted. Such changes to the set of protocols do not require significant programming steps as there is no decision tree to change. Accordingly, exemplary embodiments of the present invention are easily adaptable to changes in the set of potential protocols.

The probabilistic framework of the decision support system 11 selects one or more protocols from the knowledge database 15 by identifying those protocols that are most appropriate under the circumstances. This may be accomplished, for example, by considering each available protocol and attributing to it a probability that the given protocol is appropriate. The one or more most appropriate protocols are then selected and used to generate decision support guidance 16 (Step S28).

One or more probabilistic frameworks may be applied to assess the probability of each available protocol. For example, a Bayesian framework may be used. In such a case, each protocol is considered a hypothesis and the Bayesian framework discriminates between each hypothesis by attributing a probability to each hypothesis and selecting as “true” those hypotheses with the highest probabilities, in accordance with the formula:

$$P ( H \text{\textbar} E ) = \frac{P ( E \text{\textbar} H ) P ( H )}{P ( E )} \qquad ( 1 )$$

where H represents a specific hypothesis (protocol) or the null hypothesis, P(H) is the prior probability of H as inferred prior to the evidence E (the parsed, received and calculated data pertaining to patient preferences, patient characteristics, cancer characteristics, etc.). P(E|H) is the conditional probability of seeing the evidence E if the hypothesis H happens to be true. This probability may also be referred to as the “likelihood function” when considered as a function of H for a fixed value E. P(E) is the “marginal probability” for E, the probability of seeing the evidence E under all possible hypotheses. The marginal probability may be calculated as the sum of the product of all probabilities of the sets of mutually exclusive hypotheses and corresponding conditional probabilities in accordance with:

P(E)=ΣP(E|Hᵢ)P(Hᵢ) (2)

P(H|E) may be referred to as the “posterior probability” of H given E.

In applying the Bayesian framework, in addition to including each available protocol in the knowledge base 15, the knowledge base 15 may also include the likelihood function P(E|H) for each protocol H. The likelihood function for each given protocol will be the probability that the particular protocol would be appropriate given the particular item of information E. This information may be ascertained in advance of the execution of the decision support system by reviewing a statistically significant number of prior data and indicating how many times a particular protocol was employed given each patient preference, patient characteristic, cancer characteristic, etc.

Other probabilistic frameworks may be used in place of or in addition to the Bayesian framework. However, each probabilistic framework will provide some measure of the probability that each given protocol should be applied. The provided guidance 16 may include the protocol with the highest probability or there may be a predetermined threshold probability above which all satisfactory protocols are provided. Accordingly, the calculated guidance 16 may include one or more possible protocols for treatment and the attending medical practitioner, for example, the oncologist, may use the provided guidance 16 as he or she sees fit in order to select a course for treatment.

As discussed above, the knowledge base may be built by reviewing a statistically significant number of prior cases for which patient preferences, patient characteristics, cancer characteristics and course of treatment (protocol) information is known. Then, for each particular preference or characteristic, the number of times a particular course of treatment has been used may be identified. A matrix may then be established showing the particular preference or characteristic and the proportion of times a particular course of treatment is used.

This concept may be best shown by simplified example as follows: Assuming there are four possible preferences or characteristics (identified as Characteristic I, Characteristic II, Characteristic III, and Characteristic IV), and two possible treatments (identified as Treatment I and Treatment II), prior case data may be as follows:

TABLE I
Prior Case Data

| | | |
|---|---|---|
| Patient 1 | Chars. I &II | Treatment I |
| Patient 2 | Chars. I &III | Treatment I |
| Patient 3 | Chars. II, III &IV | Treatment II |
| Patient 4 | Chars. III &IV | Treatment II |

Accordingly, for each given characteristic I through IV, the frequency of receiving a particular treatment protocol may be counted to determine the likelihood function for each characteristic:

TABLE II
Likelihood Functions

| | | |
|---|---|---|
| Char. I | Treatment I-100% | Treatment II-0% |
| Char. II | Treatment I-50% | Treatment II-50% |
| Char. III | Treatment I-33.3% | Treatment II-66.7% |
| Char. IV | Treatment I-0% | Treatment II-100% |

In a manner similar to the simplified example illustrated above, the likelihood function for each preference and/or characteristic may be understood and these values may be used by the decision support system to derive guidance using a probabilistic framework such as a Bayesian framework. Accordingly, as new treatment protocols are developed, the knowledge base may be easily updated by providing a table of likelihood functions for the new treatment protocol and/or by providing additional prior case data and then permitting the decision support system to calculate the likelihood functions based on the provided additional prior case data. In this way, the decision support system may be easily updated without requiring sophisticated reprogramming of a decision tree.

The output of the decision support system may include guidance as to one or more possible treatment protocols. As described above, the protocols selected for guidance may be either the top n treatment protocols with the highest probability as determined by the probabilistic framework, with n being a positive integer, or the protocols selected for guidance may be each treatment protocol with a probability above a particular threshold level, for example, 80%.

The one or more treatment protocols that are so selected for guidance may be displayed by themselves or along with the exact probability level. The exact probability may also be used to produce a confidence interval for the particular selected treatment protocol, and the produced confidence interval may be displayed as part of the guidance. The particulars of the selected treatment protocol(s) may also be displayed, and the particulars of the treatment may be furnished along with the treatment protocols themselves. For example, where it is determined that a particular treatment protocol calls for a dosage that is based on the patient's weight, the exact dosage may be calculated based on the patient's weight and displayed as part of the guidance.

Where the decision support system has determined that additional information and/or testing would be helpful, this information may be included as part of the guidance. The decision support system may. for example, calculate this information by determining which unknown characteristics are highly correlated with the one or more selected treatment protocols, and asking that this information be provided and/or suggesting a test that would be likely to produce this information.

The decision support system may also include the ability to predict potential outcomes pertaining to one or more of the selected treatment protocols. The predicted potential outcomes may be displayed as part of the generated guidance. Exemplary embodiments of the present invention may determine the predicted potential outcomes, for example, using a learning algorithm that is trained on prior outcomes. Other predictive models may be used in addition to or in place of the use of the learning algorithms. These predictive models may be based on public models or models that are learned from the data of the institution where the decision support system is installed.

This ability to predict the potential outcomes pertaining to the selected treatment protocols may be implemented as a plug-in to the above-described automatic decision support system.

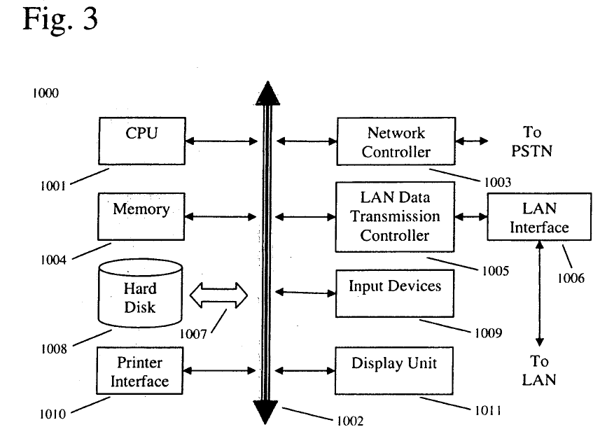

FIG. 3 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for providing automatic decision support for the selection of a treatment protocol, comprising:
receiving information pertaining to a patient, a condition of the patient, and patent preferences;
accessing a knowledge base including a plurality of treatment protocols;
selecting one or more of the plurality of treatment protocols from the knowledge base based on the received information pertaining to the patient, the condition, and the preferences, and using a probabilistic framework; and
providing the selected treatment protocols as treatment guidance.

2. The method of claim 1, wherein the information pertaining to the patient, the condition and the preferences are partially or wholly ascertained by automatically parsing patient records.

3. The method of claim 2, wherein the patient records include one or more of doctor's notes, patient billing records, patient medical histories, diagnoses, and medical images.

4. The method of claim 1, wherein the information pertaining to the patient, the condition and the preferences are partially or wholly ascertained by prompting a user for manual input of the desired data.

5. The method of claim 1, wherein the information pertaining to the patient, the condition and the preferences is used to calculate one or more surrogate variables that are also used in selecting the treatment protocols from the knowledge base using a probabilistic framework.

6. The method of claim 1, wherein the information pertaining to the condition of the patient includes information about an instance of cancer and/or the patent preferences includes information about the patient's tolerance for adverse side effects.

7. The method of claim 1, wherein the knowledge base additionally includes likelihood functions for one or more of the plurality of treatment protocols.

8. The method of claim 1, wherein the selected treatment protocols are selected from the knowledge base for having a highest probability as determined by the probabilistic framework.

9. The method of claim 1, wherein the selected treatment protocols are selected from the knowledge base for having a probability greater than a predetermined threshold as determined by the probabilistic framework.

10. The method of claim 1, wherein the provided treatment guidance includes the selected treatment protocols as well as a confidence interval for each selected treatment protocol that is based on the respective probability as determined by the probabilistic framework.

11. The method of claim 1, wherein the provided treatment guidance includes predictive outcomes for the selected treatment protocols.

12. A system for providing automatic decision support for the selection of a treatment protocol, comprising:
a record parsing unit for parsing patient records for information pertaining to a patient, a condition of the patient, or patent preferences;
an input device for receiving additional information pertaining to a patient, a condition of the patient, or patent preferences;
a knowledge base including a plurality of treatment protocols;
a logic unit employing a probabilistic framework for selecting one or more of the plurality of treatment protocols from the knowledge base based on the parsed information and the received additional information pertaining to the patient, the condition, and the preferences; and
a display device for displaying the selected treatment protocols as treatment guidance.

13. The system of claim 12, wherein the record parsing unit automatically parses one or more of doctor's notes, patient billing records, patient medical histories, diagnoses, and medical images for information pertaining to a patient, a condition of the patient, or patent preferences.

14. The system of claim 12, wherein the information pertaining to the patent preferences includes information about the patient's tolerance for adverse side effects.

15. The system of claim 12, wherein the knowledge base additionally includes likelihood functions for one or more of the plurality of treatment protocols.

16. The system of claim 12, wherein the selected treatment protocols are selected from the knowledge base for having a highest probability as determined by the probabilistic framework.

17. The system of claim 12, wherein the selected treatment protocols are selected from the knowledge base for having a probability greater than a predetermined threshold as determined by the probabilistic framework.

18. The system of claim 12, wherein the displayed treatment guidance includes the selected treatment protocols as well as a confidence interval for each selected treatment protocol that is based on the respective probability as determined by the probabilistic framework.

19. The system of claim 12, wherein the displayed treatment guidance includes predictive outcomes for the selected treatment protocols.

20. A computer system comprising:
a processor; and
a program storage device readable by the computer system, embodying a program of instructions executable by the processor to perform method steps for providing automatic decision support for the selection of a treatment protocol, the method comprising:
receiving information pertaining to a patient, a condition of the patient, and patent preferences;
accessing a knowledge base including a plurality of treatment protocols;
selecting one or more of the plurality of treatment protocols from the knowledge base based on the received information pertaining to the patient, the condition, and the preferences, and using a probabilistic framework; and
providing the selected treatment protocols as treatment guidance.
